(19) United States
(12) Patent Application Publication
(10) Pub. No.: US 2012/0306613 A1
(43) Pub. Date: Dec. 6, 2012

(54) SENSOR ALLOCATION

(75) Inventors: Michael David De La Rue, Warszawa (PL); Abhinav Singh, Gold Coast (SG); Boby Kj, Kerala (IN); Maciej Gulak, Jozefoslaw (PL); Manuel Nakamurakare, Bellavista (PE); Marco Aurelio da Costa Soeima, Santo Antonio dos Cavaleiros (PT)

(73) Assignee: NOKIA SIEMENS NETWORKS OY, Espoo (FI)

(21) Appl. No.: 13/151,432

(22) Filed: Jun. 2, 2011

(51) Int. Cl. G08B 29/00

(52) U.S. Cl. 340/5.2

(57) ABSTRACT

The present invention relates to methods and apparatus for allocating sensors. Data from an unallocated sensor is received and a unique sensor link identifier is received where the unique sensor link identifier relates to the unallocated sensor from a user device. It is determined which unallocated sensor corresponds to the unique sensor link identifier such that the user device can access the data received from the unallocated sensor.

The present invention relates to sensor allocation and, in particular, to allocating a sensor to a user account.

Machine-to-Machine (M2M) typically refers to systems in which devices (for example, sensors, meters, controllers, and so on) communicate through a network (wireless, wired or hybrid) to an application that interprets data from the devices into meaningful information for the purpose of the M2M system.

M2M systems also enable the application to communicate with the devices in order to control or affect the devices in some way (e.g. change a charge plan for meters, turn devices on/off, change settings in the devices, and so on).

M2M devices, e.g. sensors, are typically difficult to configure and set up into an operational state to allow a user of the M2M system obtain meaningful information from the M2M devices, to link a plurality of M2M devices together to form a network of M2M devices, e.g. sensors, that the user can simultaneously monitor or view meaningful information from and to manage the M2M devices.

Currently, in order to initialise the M2M devices into a user's group of M2M devices, or into a user's account with a service provider of M2M services, the user has to perform several steps which introduces complexity for the user, a higher possibility of errors or malfunctions in the M2M system for the user, the possibility of fraudulent or malicious attacks on the M2M system, and so on, which is disadvantageous to the M2M system and to the user as the added complexity may put the user off from using the M2M system.

The present invention seeks to address, at least in part, some or all of the drawbacks, disadvantages and problems described hereinabove.

According to a first aspect of the present invention there is provided a method comprising the steps of: receiving data from an unallocated sensor; receiving a unique sensor link identifier relating to said unallocated sensor from a user device; and determining said unallocated sensor corresponds to said unique sensor link identifier such that said user device can access said data received from said unallocated sensor.

The method may be implemented on a server. An unallocated sensor may be plugged in and powered up by a user and the sensor is able to transmit data form the sensor. The data is received and may be interpreted to provide meaningful information on the sensor data received. A unique sensor link identifier is received from a user device which may correspond to an unallocated sensor. The unallocated sensor corresponding to the unique sensor link identifier is determined such that a user may be able to view and access the meaningful information relating to the data from the sensor.

The method may further comprise the steps of identifying a user account; and allocating said unallocated sensor to said identified user account. Therefore, if the user identifies their account the unallocated sensor can be allocated automatically to the user account. The user may identify their account before providing the unique sensor link identifier or after providing the unique sensor link identifier.

The step of identifying said user account may comprise the steps of receiving login details of said user account; and authenticating said login details for said user account.

The method may further comprise the steps of generating a unique sensor link identifier for said unallocated sensor; and maintaining a record of unallocated sensors and corresponding unique sensor link identifiers.

According to a second aspect of the present invention there is provided an apparatus comprising: a first input adapted to receive data from an unallocated sensor; a second input adapted to receive a unique sensor link identifier relating to said unallocated sensor from a user device; and a first processor adapted to determine said unallocated sensor corresponds to said unique sensor link identifier such that said user device can access said data received from said unallocated sensor.

According to a fourth aspect of the present invention there is provided an apparatus adapted to: receive data from an unallocated sensor; receive a unique sensor link identifier relating to said unallocated sensor from a user device; and determine said unallocated sensor corresponds to said unique sensor link identifier such that said user device can access said data received from said unallocated sensor.

The apparatus may be adapted using hardware, software or any combination thereof. The processors may be adapted to interact with inputs, outputs, memory and so on in order to perform their functions.

The apparatus may further comprise a second processor adapted to identify a user account; and a third processor adapted to allocate said unallocated sensor to said identified user account.

The apparatus may further comprise a third input adapted to receive login details of said user account; and a fourth processor adapted to authenticate said login details for said user account.

The apparatus may further comprise a fifth processor adapted to generate a unique sensor link identifier for said unallocated sensor; and a sixth processor adapted to maintain a record of unallocated sensors and corresponding unique sensor link identifiers.

The first input through third input may be the same input, different inputs or any combination thereof. The first processor through sixth processor may be the same processor, different processors or any combination thereof.

According to a fourth aspect of the present invention there is provided a computer program product comprising computer readable executable code for: receiving data from an unallocated sensor; receiving a unique sensor link identifier relating to said unallocated sensor from a user device; and determining said unallocated sensor corresponds to said unique sensor link identifier such that said user device can access said data received from said unallocated sensor.

Embodiments of the present invention will now be described, by way of example only, and with reference to the accompanying drawing, in which:

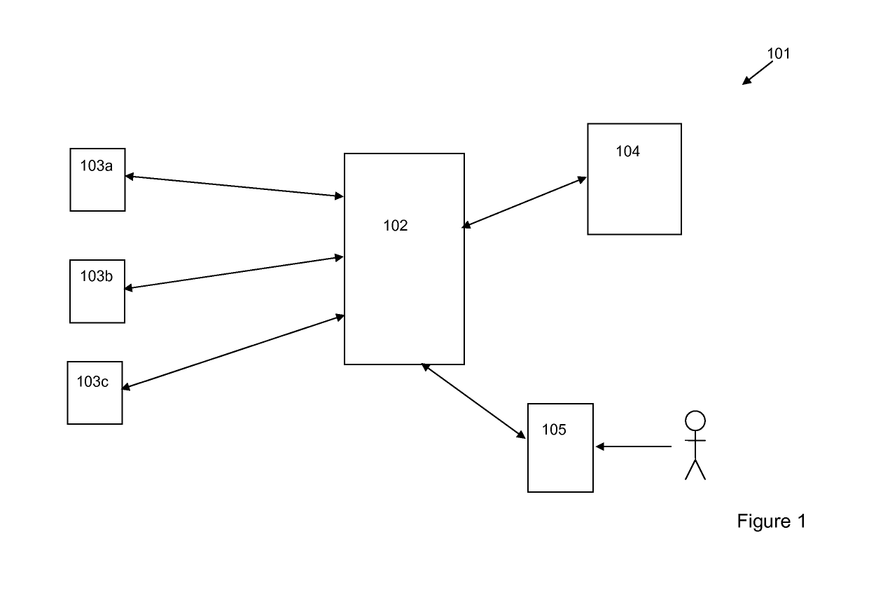

FIG. 1 shows a simplified block diagram of a system according to many of the embodiments of the present invention.

With reference to FIG. 1, the system 101 includes an application 102 that may be operated by a service provider 104. The application 102 may be operatively connected to one or more sensors 103 and operatively connected to a user device 105 of a user 106.

The application 102 may be implemented on a computing device, such as a server, a computer, and so on. The application 102 may be operatively connected to the sensors 103 and the user device 105 via wireless communication networks, wired communication networks, or any combination thereof.

A service provider 104 operating the application 102 may maintain a database, or other record or data structure, with any control information relating to each type of sensor 103 that the application 102 is to receive raw data from. Thus, the application 102 will be able to recognise each type of sensor 103 that is transmitting raw data to the application 102 and to be able to interpret the raw data from each type of sensor 103.

In addition to, or integral with, the database of control information for each type of sensor 103, the application may maintain a record, e.g. an entry in the database, for each sensor that is associated with the application 102. The application 102 may maintain a unique sensor identifier (e.g. a serial number of the sensor) and the type of sensor (so that it may be linked with or obtained the control information for that type of sensor).

The record of each sensor may also include additional parameters that may be set or which can be configured at any time. For example, the application 102 may also include parameters relating to the use or purpose of the sensor; e.g. the sensor may be a temperature sensor and so the additional parameters may be that the temperature sensor is attached to a refrigerator, or attached to a washing machine, and so on, to enable the application 102 to know the context of the temperature sensor as different contexts may cause a different interpretation of the temperature sensor data and/or control of the sensor e.g. the expected operating temperature ranges.

The implementation of the application 102 enables it to receive raw data from one or more sensors and to interpret the raw data from each type of sensor in order to provide meaningful information based on the raw data.

The application 102 may also enable users to define accounts or profiles in which the user can view or select all of the sensors that the user has installed and provide additional functionality to users with accounts, such as historical data analysis, sending commands to the user's sensors, management of sensors, and so on.

The sensors 103 may be any sensor or device, for example, movement sensors, temperature sensors, smart meters, controllers, and so on, as there are a substantial number of sensors available that can be used for any purpose and comprise the functionality to transmit data relating to an event to the application 102, which the application 102 can interpret and provide meaningful information thereon. The sensor 103 may also have the capability to receive commands or instructions from the application 102 and to act upon the commands or instructions.

The sensors 103 are preconfigured with an address of the application 102 before they are delivered or provided to a user 106. The address may be a Uniform Resource Locator (URL) or any other address that enables the sensor 103 to transmit raw data to the application 102 over wireless communication channels, wired communication channels, or any combination thereof.

The user device 105 may be any user device 105 that can communicate or interact with the application 102, for example, the user device 105 may be a mobile device (e.g. a mobile telephone, a tablet device, and so on), a computing device (e.g. a notebook, laptop, personal computer, and so on). The user device 105 may interact with and/or communicate with the application 102 via a browser on the user device 105 or by any other means in order to interact with the application 102.

A user 106 may request or order a sensor 103a from the service provider 104, via the application 102, via a third party stockist or manufacturer, or by any other means.

In this example, the user 106 orders a sensor 103a from the service provider 104, where in this example the sensor 103a is a temperature sensor. The service provider 104 identifies the sensor 103a to be delivered to the user 106. For example, the service provider 104 may maintain a warehouse of sensors, may request a sensor from a manufacturer or stockist, and so on.

As the sensors 103 are preconfigured with an address of the application 102 then the application 102 may maintain the database of the sensors that have been preconfigured with the address of the application 102. As described hereinabove the database may contain a unique sensor identifier and the type of sensor. If the service provider 104 orders or obtains the sensor from a manufacturer or stockist then on receipt of the sensor the database may be updated with the sensor details or the manufacturer/stockist may provide electronically the sensor details to the application 102.

The application 102 will generate and associate a unique sensor link identifier for each sensor 103. The unique sensor link identifier may be, for example, in the form of a Uniform Resource Locator (URL), a numeric code, an alphanumeric code, and so on.

The unique sensor link identifier may be generated and associated with a sensor once the sensor is chosen to be the sensor to be delivered or provided to the user 106. Alternatively or in combination, the application 102 may generate the unique sensor link identifier for all sensors that are maintained or stored in the application 102, or in a database integral to the application 102, or operatively connected thereto.

The sensor 103 when delivered or provided to a user 106 may include the unique sensor link identifier for the sensor 103a. For example, the unique sensor link identifier may be provided as a written instruction to the user 106 in the box that the sensor 103 is provided in. Alternatively, or in combination, the unique sensor link identifier may be provided to the user 106 electronically, for example, as an e-mail, a Short Message Service (SMS) message, and so on.

As mentioned hereinabove, in this example the sensor 103a is a temperature sensor. The user 106 on receiving the temperature sensor 103a unpacks the temperature sensor 103a and turns on the sensor 103a at its desired position. The temperature sensor 103a has been preconfigured with the address of the application 102 and so the temperature sensor 103a substantially immediately starts to transmit its raw data, relating to temperature measurements, to the preconfigured address of the application 102 without any need for any configuration or installation by the user 106, further than simply turning the sensor 103a on and connecting any necessary cables (for example, if wired communication channels are used).

The application 102 will receive the raw data from the temperature sensor 103a which the application 102 will recognise. For example, the temperature sensor 103a may transmit its unique sensor identifier to the application 102, either with or before the raw data, so that the application 102 can identify from its database the temperature sensor and any associated control information, additional parameters (e.g. security information, the context of the temperature sensor, and so on). However, at this stage the sensor 103a is unallocated to any user 106 account or profile.

The application 102 on recognising the sensor 103a may, based on control information in the database, communicate with the sensor 103a to provide configuration data to the sensor 103a. Thus, if the sensor requires any configuration the application 102 can trigger the configuration of the unallocated sensor 103a.

The user 106, via their user device 105, inputs the unique sensor link identifier to the application 102. For example, if the unique sensor link identifier is an alphanumeric code then the user 106 may direct a browser on the user device 105 to the web site of the application and inputs the alphanumeric code into the application.

Alternatively, the unique sensor link identifier may be a URL which the user 106 inputs into the browser on the user device 105 which directs the browser to the address of the URL.

In this example, the user 106 inputs a URL into the browser on the user's device 105, which may be, for example:

http://www.application.com/newsensor/unique sensor link identifier

The application 102 receives the unique sensor link identifier for the unallocated sensor 103a, e.g. the temperature sensor, which has been turned on by the user 106. Based on the received unique sensor link identifier the application 102 may interrogate the entries or records in the database that is part of or operatively connected to, the application 102 in order to identify the unallocated temperature sensor 103a. On identifying the unallocated temperature sensor 103a relating to the unique sensor link identifier the application 102 may provide a view or representation of meaningful information based on the raw data that the application is receiving from the unallocated temperature sensor 103a in the browser on the user's device 105.

The user 106 may direct the browser on any user device 105 any number of times to the URL in order to access and/or view information from the unallocated sensor 103a. Though the service provider may wish to limit the access to a particular number of times.

As the temperature sensor 103a is unallocated then the user 106 will have limited functionality and services provided in respect of the unallocated sensor 103a. For example, the user 106 may be able to view a representation of the meaningful information relating to the temperature sensor 103a, but cannot view historical data, provide commands or instructions to the sensor, manage the sensor, and so on. The service provider 104 may decide to implement any level of service or functionality for a user 106 accessing an unallocated sensor. An advantage to the user 106 of viewing an unallocated sensor is that the user 106 can determine that the sensor is operating or functioning correctly and may simply be interested in viewing real-time information regarding the sensor without needing to sign up to an account with the service provider 104. The user 106 may also want to try the service prior to signing up to an account with the service provider 104.

However, if the user 106 requires more functionality, wishes to manage sensors 103, for example, if the user 106 has already a set of one or more sensors and wishes to add the new sensor to those already owned by the user 106, and so on, then the user 106 may want to link the sensor 103a to their account.

The user 106 may already have an account with the service provider 104, or at the stage of obtaining and installing their first sensor the user 106 may wish to sign up to an account.

In this example, the user 106 already has an account with the service provider 104. Furthermore, the user 106 has previously installed and linked two other temperature sensors 103b and 103c to their user account.

The unallocated temperature sensor 103a may be allocated to the user's 106 account automatically once the application 102 is aware of the user's 106 account and the unique sensor link identifier. For example, whilst viewing the unallocated temperature sensor 103a information from the application 102 (e.g. the user 106 directed their browser to the URL for the sensor 103a), the user 106, via the browser on the user device 105, may enter their login details (e.g. username and password combination) to access the user's 106 account. The application 102 validates and/or authenticates the user 106 and provides a view of the user's 106 account in the browser of the user device 105. As the application 102 is now aware of the user's account and the unique sensor link identifier, the unallocated temperature sensor 103a can then be allocated to the user's account enabling the user 106 to manage the temperature sensor 103a, have more functionality and services from the service provider 104, and so on.

The application 102 may update the user's account to indicate that the temperature sensor 103a belongs to the user 106. The application 102 may update the database of the records for each sensor to indicate that the sensor is linked or allocated to a particular user's 106 account.

In the above example, the user 106 logged into their account after viewing the unallocated temperature sensor 103a and the application 102 then allocated the temperature sensor to the user's account. In another example, the user 106 via their user device 105 may first log in to their account with the service provider 104 of the application 102 and then enter the unique sensor link identifier, e.g. the URL, which triggers the application 102 to allocate the unallocated temperature sensor 103a to the user's account.

Therefore, many of the embodiments advantageously enable a user to receive a sensor and, without any complicated set-up or configuration by the user, view information from the sensor and link the sensor to the user's account.

While preferred embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method, comprising:
identifying a first product that is next to be dispensed in a vending machine;
determining an expiry date of said first product; and
triggering one or more first corrective actions if current date is within a predefined time period of said expiry date of said first product.

2. The method as claimed in claim 1, wherein said identifying said first product to be dispensed comprises:
receiving an initial position of said first product in said vending machine;
receiving information on one or more second products dispensed in said vending machine; and
tracking a position of said first product based on said received information on one or more of said second products.

3. The method as claimed in claim 1, wherein said identifying said first product to be dispensed comprises:
receiving an identification of said first product from said vending machine when said first product is next to be dispensed.

4. The method as claimed in claim 1, further comprising:
identifying said one or more first corrective actions to trigger based on one or more predefined first criteria.

5. The method as claimed in claim 1, further comprising:
triggering one or more second corrective actions if current date is after said expiry date of said first product.

6. The method as claimed in claim 5, further comprising:
identifying said one or more second corrective actions to trigger based on one or more predefined second criteria.

7. The method as claimed in claim 1, further comprising:
periodically determining if said current date is within said predefined time period of said expiry date of said first product.

8. The method as claimed in claim 5, further comprising:
periodically determining if said current date is after said expiry date of said first product.

9. An apparatus, comprising:
a first processor configured to identify a first product that is next to be dispensed in a vending machine;
a second processor configured to determine an expiry date of said first product; and
a third processor configured to trigger one or more corrective actions if current date is within a predefined time period of said expiry date of said first product.

10. The apparatus as claimed in claim 9, further comprising:
a first input configured to receive an initial position of said first product in said vending machine;
a second input configured to receive information on one or more second products dispensed in said vending machine; and
a fourth processor configured to track a position of said first product based on said received information on one or more of said second products.

11. The apparatus as claimed in claim 9, further comprising:
a third input configured to receive an identification of said first product from said vending machine when said first product is next to be dispensed.

12. The apparatus as claimed in claim 9, further comprising:
a fifth processor configured to identify said one or more first corrective actions to trigger based on one or more predefined first criteria.

13. The apparatus as claimed in claim 9, further comprising:
a sixth processor configured to trigger one or more second corrective actions if current date is after said expiry date of said first product.

14. The apparatus as claimed in claim 13, further comprising:
a seventh processor configured to identify said one or more second corrective actions to trigger based on one or more predefined second criteria.

15. The apparatus as claimed in claim 9, further comprises:
an eighth processor configured to periodically determine if said current date is within said predefined time period of said expiry date of said first product.

16. The apparatus as claimed in claim 13, further comprising:
a ninth processor configured to periodically determine if said current date is after said expiry date of said first product.

17. A computer program product comprising computer readable executable code which, when run on a processor, controls said processor to perform a method comprising:
identifying a first product that is next to be dispensed in a vending machine;
determining an expiry date of said first product; and
triggering one or more corrective actions if current date is within a predefined time period of said expiry date of said first product.
